(19) United States
(12) Patent Application Publication
(10) Pub. No.: US 2026/0226273 A1
(43) Pub. Date: Aug. 6, 2026

(54) ASPHALT COMPOSITION AND ASPHALT MIX

(71) Applicant: IDEMITSU KOSAN CO.,LTD., Tokyo (JP)

(72) Inventors: Michika TOKUNAGA, Chiyoda-ku (JP); Masami KANAMARU, Chiyoda-ku (JP); Yutaka MINAMI, Chiyoda-ku (JP)

(73) Assignee: IDEMITSU KOSAN CO.,LTD., Tokyo (JP)

(21) Appl. No.: 19/154,145

(22) PCT Filed: Feb. 26, 2024
(86) PCT No.: PCT/JP2024/006747

§ 371 Date: Aug. 6, 2025

(30) Foreign Application Priority Data
Feb. 28, 2023 (JP) 2023-029609

(51) Int. Cl. C08L 95/00; C08F 8/04

(52) U.S. Cl. CPC C08L 95/00; C08F 8/04; C08L 2555/52; C08L 2555/84

(57) ABSTRACT

An asphalt composition including: a petroleum resin (A) and straight asphalt, where the petroleum resin (A) is a petroleum resin obtained by copolymerization of: a monomer containing at least one kind of cyclic olefin having an ethylenically unsaturated group selected from a C5 fraction, a C8 fraction, and a C9 fraction of cracked naphtha, and a cyclopentadiene-based compound; and a silane, and where the petroleum resin (A) satisfies the following conditions: the petroleum resin (A) contains 0.1 mass % to 10 mass % of silicon element in terms of silicon atoms; and the petroleum resin (A) has a weight-average molecular weight (Mw) of 500 to 3,000.

### TECHNICAL FIELD

The present invention relates to an asphalt composition and an asphalt mixture, and a petroleum resin and a hydrogenated petroleum resin to be used for the asphalt composition and the asphalt mixture.

### BACKGROUND ART

In recent years, as a major factor for damage to an asphalt pavement, there has been given an asphalt peeling phenomenon in which asphalt covering a surface of aggregate is peeled owing to permeation of, for example, rainwater or groundwater between the asphalt and the aggregate. When such asphalt peeling phenomenon occurs, a function of bonding the aggregates to each other is reduced, and damage, such as a crack or a pothole, may be liable to occur. Accordingly, the research and development of an asphalt composition that can suppress the peeling of asphalt have been advanced.

For example, in PTL 1, there is a disclosure of a method of producing a modified hydrogenated petroleum resin, the method including causing a hydrogenated petroleum resin, and a compound having a carbon-carbon double bond and an alkoxysilyl group to react with each other in the presence of a compound that generates a radical, and there is also a disclosure of an asphalt composition including a modified hydrogenated petroleum resin and straight asphalt, wherein a content of the straight asphalt is from 70.00 mass % to 99.99 mass %.

### CITATION LIST

### Patent Literature

PTL 1: WO 2021/161672 A1

### SUMMARY OF INVENTION

### Technical Problem

In PTL 1, an investigation for obtaining an asphalt composition that can suppress the peeling of asphalt has been conducted, but there is room for further improvement from the viewpoint of improving the water resistance of an asphalt mixture.

In view of the foregoing, an object of the present invention is to provide an asphalt composition that can suppress the peeling of asphalt and that can improve the water resistance of an asphalt mixture.

### Solution to Problem

The inventors of the present invention have found that the above-mentioned object can be achieved by an asphalt composition including: a petroleum resin (A) containing a specific amount of silicon element, having a specific weight-average molecular weight, and having a specific structure; and straight asphalt. That is, the present invention provides the following items <1> to <8>.

<1>

An asphalt composition, comprising:
a petroleum resin (A); and
straight asphalt,
wherein the petroleum resin (A) is a petroleum resin obtained by copolymerization of: a monomer containing at least one kind of cyclic olefin having an ethylenically unsaturated group selected from a C5 fraction, a C8 fraction, and a C9 fraction of cracked naphtha, and a cyclopentadiene-based compound; and a silane, and
wherein the petroleum resin (A) satisfies the following conditions (a1) and (a2):
(a1) the petroleum resin (A) contains 0.1 mass % or more and 10 mass % or less of silicon element in terms of silicon atoms; and
(a2) the petroleum resin (A) has a weight-average molecular weight (Mw) of 500 or more and 3,000 or less.
   <2>

The asphalt composition according to the above-mentioned item <1>, wherein the petroleum resin (A) satisfies the following condition (a3):
(a3) the petroleum resin (A) has a softening point of from 70° C. to 150° C.
   <3>

The asphalt composition according to the above-mentioned item <1> or <2>, wherein the silane has a structure represented by the following formula (1):

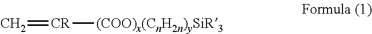

wherein
in the formula (1), R represents a hydrogen atom or a methyl group, “x” and “y” each represent 0 or 1, provided that when “x” represents 1, “y” represents 1, “n” represents an integer of from 1 to 12, and R's each independently represent an alkoxy group having 1 to 12 carbon atoms, an aryloxy group, an aralkyloxy group, an aliphatic acyloxy group having 1 to 12 carbon atoms, an amino or substituted amino group, or a lower alkyl group having 1 to 6 carbon atoms, provided that two or less of the three R′ groups are each an alkyl group.
   <4>

The asphalt composition according to any one of the above-mentioned items <1> to <3>, wherein the silane is at least one kind selected from vinyltrimethoxysilane, vinyltriethoxysilane, and 3-(trimethoxysilyl) propyl methacrylate.

<5>

The asphalt composition according to any one of the above-mentioned items <1> to <4>, wherein the monomer contains dicyclopentadiene.

<6>

The asphalt composition according to any one of the above-mentioned items <1> to <5>, wherein the petroleum resin (A) is a hydrogenated product.

<7>

The asphalt composition according to any one of the above-mentioned items <1> to <6>, wherein a content of the petroleum resin (A) in the asphalt composition is 0.1 mass % or more and 5 mass % or less.

<8>

An asphalt mixture, comprising:
the asphalt composition of any one of the above-mentioned items <1> to <7>; and
aggregate,
wherein a content of the asphalt composition is from 1 mass % to 20 mass %.

In addition, the inventors of the present invention have found that the above-mentioned object can be achieved by a petroleum resin (B) containing a specific amount of silicon element, having a specific weight-average molecular weight, and having a specific structure. That is, the present invention provides the following items <9> to <17>.

<9>

A petroleum resin (B), which is obtained by copolymerization of:
a monomer containing at least one kind of cyclic olefin having an ethylenically unsaturated group selected from a C5 fraction, a C8 fraction, and a C9 fraction of cracked naphtha, and a cyclopentadiene-based compound; and
a silane,
wherein the petroleum resin (B) satisfies the following conditions (b1) and (b2):
(b1) the petroleum resin (B) contains 0.1 mass % or more and 10 mass % or less of silicon element in terms of silicon atoms; and
(b2) the petroleum resin (B) has a weight-average molecular weight (Mw) of 500 or more and 3,000 or less.
   <10>

The petroleum resin (B) according to the above-mentioned item <9>, wherein the petroleum resin (B) satisfies the following condition (b3):
(b3) the petroleum resin (B) has a softening point of from 70° C. to 150° C.
   <11>

The petroleum resin (B) according to the above-mentioned item <9> or <10>, wherein the silane has a structure represented by the following formula (1):

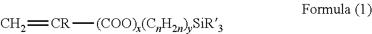

wherein
in the formula (1), R represents a hydrogen atom or a methyl group, “x” and “y” each represent 0 or 1, provided that when “x” represents 1, “y” represents 1, “n” represents an integer of from 1 to 12, and R's each independently represent an alkoxy group having 1 to 12 carbon atoms, an aryloxy group, an aralkyloxy group, an aliphatic acyloxy group having 1 to 12 carbon atoms, an amino or substituted amino group, or a lower alkyl group having 1 to 6 carbon atoms, provided that two or less of the three R′ groups are each an alkyl group.
   <12>

The petroleum resin (B) according to any one of the above-mentioned items <9> to <11>, wherein the silane is at least one kind selected from vinyltrimethoxysilane, vinyltriethoxysilane, and 3-(trimethoxysilyl) propyl methacrylate.

<13>

The petroleum resin (B) according to any one of the above-mentioned items <9> to <12>, wherein the monomer contains dicyclopentadiene.

<14>

The petroleum resin (B) according to any one of the above-mentioned items <9> to <13>, wherein the petroleum resin (B) is a hydrogenated product.

<15>

An asphalt composition, comprising:
the petroleum resin (B) of any one of the above-mentioned items <9> to <14>; and
straight asphalt.
   <16>

The asphalt composition according to the above-mentioned item <15>, wherein a content of the petroleum resin (B) in the asphalt composition is 0.1 mass % or more and 5 mass % or less.

<17>

An asphalt mixture, comprising:
the asphalt composition of the above-mentioned item <15> or <16>; and
aggregate,
wherein a content of the asphalt composition is from 1 mass % to 20 mass %.

In addition, the inventors of the present invention have found that the above-mentioned object can be achieved by a hydrogenated petroleum resin (C) containing a specific amount of silicon element, having a specific weight-average molecular weight, and having a specific structure. That is, the present invention provides the following items <18> to <25>.

<18>

A hydrogenated petroleum resin (C), which is obtained by copolymerization of:
a monomer containing at least one kind of cyclic olefin having an ethylenically unsaturated group selected from a C5 fraction, a C8 fraction, and a C9 fraction of cracked naphtha, and a cyclopentadiene-based compound; and
a silane,
wherein the hydrogenated petroleum resin (C) satisfies the following conditions (c1) and (c2):
(c1) the hydrogenated petroleum resin (C) contains 0.1 mass % or more and 10 mass % or less of silicon element in terms of silicon atoms; and
(c2) the hydrogenated petroleum resin (C) has a weight-average molecular weight (Mw) of 500 or more and 3,000 or less.
   <19>

The hydrogenated petroleum resin (C) according to the above-mentioned item <18>, wherein the hydrogenated petroleum resin (C) satisfies the following condition (c3):
(c3) the hydrogenated petroleum resin (C) has a softening point of from 70° C. to 150° C.
   <20>

The hydrogenated petroleum resin (C) according to the above-mentioned item <18> or <19>, wherein the silane has a structure represented by the following formula (1):

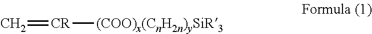

wherein
in the formula (1), R represents a hydrogen atom or a methyl group, “x” and “y” each represent 0 or 1, provided that when “x” represents 1, “y” represents 1, “n” represents an integer of from 1 to 12, and R's each independently represent an alkoxy group having 1 to 12 carbon atoms, an aryloxy group, an aralkyloxy group, an aliphatic acyloxy group having 1 to 12 carbon atoms, an amino or substituted amino group, or a lower alkyl group having 1 to 6 carbon atoms, provided that two or less of the three R′ groups are each an alkyl group.
   <21>

The hydrogenated petroleum resin (C) according to any one of the above-mentioned items <18> to <20>, wherein the silane is at least one kind selected from vinyltrimethoxysilane, vinyltriethoxysilane, and 3-(trimethoxysilyl) propyl methacrylate.

<22>

The hydrogenated petroleum resin (C) according to any one of the above-mentioned items <18> to <21>, wherein the monomer contains dicyclopentadiene.

<23>

An asphalt composition, comprising:
the hydrogenated petroleum resin (C) of any one of the above-mentioned items <18> to <22>; and
straight asphalt.
   <24>

The asphalt composition according to the above-mentioned item <23>, wherein a content of the hydrogenated petroleum resin (C) in the asphalt composition is 0.1 mass % or more and 5 mass % or less.

<25>

An asphalt mixture, comprising:
the asphalt composition of the above-mentioned item <23> or <24>; and
aggregate,
wherein a content of the asphalt composition is from 1 mass % to 20 mass %.

### Advantageous Effects of Invention

According to the present invention, the asphalt composition that can suppress the peeling of asphalt and that can improve the water resistance of an asphalt mixture can be provided.

### DESCRIPTION OF EMBODIMENTS

The present invention is described in detail below. However, the contents of the present invention are not limited to embodiments to be described below.

### Description of Terms

In the present invention, the expression “from X to Y” (X and Y each represent any numeral) encompasses the meanings of “preferably more than X” and “preferably less than Y” as well as the meaning of “X or more and Y or less” unless otherwise stated.

### [First Invention: Asphalt Composition]

An asphalt composition according to a first invention is described below.

The asphalt composition includes a petroleum resin (A) and straight asphalt.

The petroleum resin (A) is a petroleum resin obtained by copolymerization of: a monomer containing at least one kind of cyclic olefin having an ethylenically unsaturated group selected from a C5 fraction, a C8 fraction, and a C9 fraction of cracked naphtha, and dicyclopentadiene; and a silane.

The petroleum resin (A) satisfies the following conditions (a1) and (a2):
(a1) the petroleum resin (A) contains 0.1 mass % or more and 10 mass % or less of silicon element in terms of silicon atoms; and
(a2) the petroleum resin (A) has a weight-average molecular weight (Mw) of 500 or more and 3,000 or less.

The above-mentioned physical properties of the petroleum resin (A) may be appropriately adjusted by the selection of a raw material monomer, the selection of a polymerization solvent, and the selection of a catalyst, the usage amounts thereof, a polymerization temperature, a reaction pressure, and other polymerization conditions.

According to the first invention, the following effect is exhibited. The asphalt composition that can suppress the peeling of asphalt and that can improve the water resistance of an asphalt mixture can be provided. The reason for the effect is not necessarily clear, but is conceived to be as described below.

An asphalt road is formed by the bonding of aggregates to each other through adhesion between the aggregate and asphalt. The aggregate is a substance having a hydroxy group on a surface thereof and having high polarity, and hence the affinity for water is larger than the affinity for asphalt. Accordingly, when water is present, the adhesion between the aggregate and the asphalt is inhibited, and the peeling of asphalt is liable to occur. Further, the asphalt road may be damaged by a load of an automobile, a truck, or the like.

According to the first invention, it is conceived that the affinity between aggregate and asphalt is improved by a reaction between a hydroxy group on a surface of the aggregate and a silane-containing group of the petroleum resin (A) in the asphalt composition. Thus, it is conceived that the peeling of asphalt is suppressed even under the presence of water, and hence the adhesion property between the aggregate and the asphalt is improved.

The above-mentioned mechanism with regard to the effect of the present invention is a presumption, and the mechanism is not limited thereto.

### <Petroleum Resin (A)>

The petroleum resin (A) satisfies the following conditions (a1) and (a2):
(a1) the petroleum resin (A) contains 0.1 mass % or more and 10 mass % or less of silicon element in terms of silicon atoms; and
(a2) the petroleum resin (A) has a weight-average molecular weight (Mw) of 500 or more and 3,000 or less.

The petroleum resin (A) contains 0.1 mass % or more and 10 mass % or less, preferably 0.3 mass % or more, more preferably 0.4 mass % or more, still more preferably 0.5 mass % or more, even still more preferably 1.0 mass % or more, even still more preferably 1.5 mass % or more, even still more preferably 2.0 mass % or more, even still more preferably 2.5 mass % or more, even still more preferably more than 2.9 mass %, even still more preferably 3.0 mass % or more, and preferably 8 mass % or less, more preferably 6 mass % or less, still more preferably 5 mass % or less of silicon element in terms of silicon atoms. Herein, the silicon element is preferably derived from an organic silane structure.

When the concentration of the silicon element in the petroleum resin (A) is less than the above-mentioned ranges (less than 0.3 mass %), it may become difficult to suppress the peeling of the asphalt from the aggregate.

Meanwhile, when the concentration of the silicon element in the petroleum resin (A) is more than the above-mentioned ranges (more than 10 mass %), molecules of the petroleum resin (A) may be cross-linked to each other, and hence the solubility of the petroleum resin (A) in the asphalt is reduced. Accordingly, expected performance may not be exhibited.

The concentration of the silicon element may be measured by ICP emission spectroscopy, and may be specifically determined by a method described in Examples.

The petroleum resin (A) has a weight-average molecular weight (Mw) of 500 or more and 3,000 or less, preferably 700 or more, more preferably 1,000 or more, still more preferably 1,200 or more, even still more preferably 1,300 or more, and preferably 3,000 or less, more preferably 2,800 or less, still more preferably 2,500 or less, even still more preferably 2,000 or less, even still more preferably 1,500 or less.

When the weight-average molecular weight (Mw) of the petroleum resin (A) is less than the above-mentioned ranges (less than 500), the asphalt composition may have an insufficient hardness at normal temperature and may become brittle to have reduced strength, and hence the durability of an asphalt road may be reduced.

Meanwhile, when the weight-average molecular weight (Mw) of the petroleum resin (A) is more than the above-mentioned ranges (more than 3,000), the viscosity thereof at the time of mixing with asphalt at high temperature may be increased, and the mixing performance thereof with the asphalt may be degraded. Accordingly, sufficient water resistance may not be exhibited.

In addition, the petroleum resin (A) has a molecular weight distribution (Mw/Mn) of preferably 5.0 or less, more preferably 4.0 or less, still more preferably 3.5 or less, even still more preferably 3.0 or less, even still more preferably 2.5 or less from the viewpoint of improving the adhesion property between the aggregate and the asphalt.

The weight-average molecular weight (Mw) and the number-average molecular weight (Mn) are each a molecular weight in terms of polystyrene. The molecular weights may each be measured by a gel permeation chromatograph (GPC) method, and may each be specifically determined by a method described in Examples.

The petroleum resin (A) preferably satisfies the following condition (a3):
(a3) the petroleum resin (A) has a softening point of from 70° C. to 150° C.

The petroleum resin (A) has a softening point of preferably from 70° C. to 150° C., more preferably from 80° C. to 140° C., still more preferably from 90° C. to 140° C., even still more preferably from 95° C. to 135° C. from the viewpoint of improving the adhesion property between the aggregate and the asphalt.

The softening point may be measured in conformity with JIS K 6863:1994.

The petroleum resin (A) preferably satisfies the following condition (a4):
(a4) the petroleum resin (A) has a bromine number of from 0.5 g/100 g to 30 g/100 g.

The petroleum resin (A) has a bromine number of preferably from 0.5 g/100 g to 30 g/100 g, more preferably from 1.0 g/100 g to 25 g/100 g, still more preferably from 2.0 g/100 g to 20 g/100 g, even still more preferably from 3.0 g/100 g to 18 g/100 g, even still more preferably from 3.0 g/100 g to 15 g/100 g from the viewpoint of improving the adhesion property between the aggregate and the asphalt.

The bromine number may be measured in conformity with JIS K 2605:1996.

The petroleum resin (A) includes a repeating unit derived from a monomer and a repeating unit derived from a silane, and is preferably obtained by copolymerization of a monomer and a silane.

### (Monomer)

The monomer for forming the petroleum resin (A) contains at least one kind of cyclic olefin having an ethylenically unsaturated group selected from a C5 fraction, a C8 fraction, and a C9 fraction of cracked naphtha, and a cyclopentadiene-based compound, preferably contains a cyclopentadiene-based compound, and more preferably contains dicyclopentadiene.

Further, a cyclopentadiene-based compound serving as a first raw material and a vinyl aromatic compound serving as a second raw material are preferably used as the monomers, and the first raw material may be used alone without the use of the second raw material.

Examples of the cyclopentadiene-based compound include cyclopentadiene, methylcyclopentadiene, ethylcyclopentadiene, and dimers and codimers thereof. Among them, dicyclopentadiene is preferred as the cyclopentadiene-based compound.

Examples of the vinyl aromatic compound include styrene, α-methylstyrene, β-methylstyrene, vinyltoluene, vinylxylene, indene, methylindene, and ethylindene. Among them, styrene is preferred as the vinyl aromatic compound.

A mixing ratio between the cyclopentadiene-based compound and the vinyl aromatic compound is not particularly limited, and the ratio “cyclopentadiene-based compound: vinyl aromatic compound” is preferably from 80:20 to 20:80, more preferably from 75:25 to 25:75 in terms of mass ratio.

### (Silane)

The silane for forming the petroleum resin (A) is not particularly limited, but preferably has a structure represented by the following formula (1):

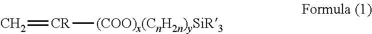

wherein
in the formula (1), R represents a hydrogen atom or a methyl group, “x” and “y” each represent 0 or 1, provided that when “x” represents 1, “y” represents 1, “n” represents an integer of from 1 to 12, preferably from 1 to 4, and R's each independently represent an alkoxy group having 1 to 12 carbon atoms (e.g., a methoxy, ethoxy, or butoxy group), an aryloxy group (e.g., a phenoxy group), an aralkyloxy group (e.g., a benzyloxy group), an aliphatic acyloxy group having 1 to 12 carbon atoms (e.g., a formyloxy, acetyloxy, or propanoyloxy group), an amino or substituted amino group (an alkylamino or arylamino group), or a lower alkyl group having 1 to 6 carbon atoms, provided that two or less of the three R′ groups are each an alkyl group.

In the formula (1), R preferably represents a hydrogen atom from the viewpoint of improving the adhesion property between the asphalt composition and the aggregate, “x” and/or “y” preferably represents 0, and “x” and “y” each more preferably represent 0.

In addition, in the formula (1), R's each represent preferably an alkoxy group having 1 to 12 carbon atoms (e.g., a methoxy, ethoxy, or butoxy group), more preferably an alkoxy group having 1 to 5 carbon atoms, still more preferably an alkoxy group having 1 to 3 carbon atoms from the viewpoint of improving the adhesion property between the asphalt composition and the aggregate.

The silane is preferably at least one kind selected from vinyltrimethoxysilane, vinyltriethoxysilane, and 3-(trimethoxysilyl) propyl methacrylate from the viewpoint of improving the adhesion property between the asphalt composition and the aggregate.

The petroleum resin (A) is preferably a hydrogenated product obtained by hydrogenation (hydrogen addition) from the viewpoint of improving the adhesion property between the asphalt composition and the aggregate. The hydrogenated product of the petroleum resin (A) may be a partially hydrogenated type in which the petroleum resin (A) is partially hydrogenated, or may be a completely hydrogenated type in which the petroleum resin (A) is completely hydrogenated.

The petroleum resin (A) may have a form of a copolymer as described above, and the difference in structure thereof as compared to the resin of PTL 1, which may have a form of a modified product, is as described below.

In the modified product, a radical attacks the petroleum resin and a silane is added to a decomposed moiety, and hence a modified moiety has a low molecular weight and Si is added to a low molecular weight side. Meanwhile, in the copolymer, monomers each have substantially equal copolymerizability, and hence Si is uniformly added.

That is, Si is uniformly added in the copolymer, and hence even when the content of Si is increased, a site where Si is locally present is not generated. As a result, a high content of Si can be achieved without causing gelation. Meanwhile, Si is nonuniformly added in the modified product, and hence a portion with a high Si concentration is present in a molecule (a site where Si is locally present is generated), the ratio of Si that effectively acts with a hydroxy group on the surface of the aggregate is reduced, and the probability of the presence of a molecule having no Si added thereto is increased. Accordingly, the improving effect on the water resistance is reduced.

Accordingly, a higher improving effect on the water resistance can be expected to be exhibited when the petroleum resin (A) is used for an asphalt mixture from the viewpoint that a higher content of Si can be achieved by the form of the copolymer than the form of the modified product.

### <Method of Producing Petroleum Resin (A)>

A method of producing the petroleum resin (A) is not particularly limited, and for example, the petroleum resin (A) is preferably formed as follows: the above-mentioned monomer, the above-mentioned silane, and a solvent for polymerization are supplied into a polymerization reaction vessel; and the above-mentioned monomer and the above-mentioned silane are subjected to a copolymerization reaction under predetermined conditions.

The usage amount of the silane is preferably from 0.1 part by mass to 80 parts by mass, more preferably from 0.5 part by mass to 50 parts by mass, still more preferably from 1 part by mass to 30 parts by mass, even still more preferably from 5 parts by mass to 28 parts by mass with respect to 100 parts by mass of the monomer.

Herein, typical examples of the solvent for polymerization include an aromatic solvent, a naphthene-based solvent, and an aliphatic hydrocarbon-based solvent. Toluene, xylene, cyclohexane, methylcyclohexane, dimethylcyclohexane, and ethylcyclohexane are suitably used as specific examples of the solvent for polymerization.

The usage amount of the solvent for polymerization is preferably from 10 parts by mass to 300 parts by mass, more preferably from 20 parts by mass to 200 parts by mass, still more preferably from 30 parts by mass to 100 parts by mass with respect to 100 parts by mass of the monomer.

The predetermined conditions in the copolymerization reaction are not particularly limited, and a reaction temperature is preferably from 150° C. to 350° C., more preferably from 200° C. to 350° C., still more preferably from 230° C. to 300° C., a reaction pressure is preferably from 0 MPaG to 5 MPaG, more preferably from 0 MPaG to 3 MPaG, still more preferably from 0.1 MPaG to 2 MPaG, and a reaction time is preferably from 1 hour to 10 hours, more preferably from 1 hour to 8 hours, still more preferably from 1 hour to 5 hours. “G” in “MPaG” refers to a gauge pressure.

In addition, a method of producing the petroleum resin (A) as a hydrogenated product is not particularly limited, and for example, the hydrogenated product of the petroleum resin (A) is preferably formed as follows: in a hydrogenation reaction vessel, the petroleum resin (A) is dissolved in a hydrogenation solvent; and hydrogen is added under predetermined conditions in the presence of a hydrogenation reaction catalyst as required to perform a hydrogenation reaction.

Herein, examples of the hydrogenation solvent include cyclohexane, methylcyclohexane, dimethylcyclohexane, ethylcyclohexane, and tetrahydrofuran.

The usage amount of the hydrogenation solvent is preferably from 30 parts by mass to 300 parts by mass, more preferably from 50 parts by mass to 250 parts by mass, still more preferably from 70 parts by mass to 150 parts by mass with respect to 100 parts by mass of the petroleum resin (A).

In addition, an example of the hydrogenation reaction catalyst is a catalyst containing at least one kind of metal component selected from nickel, palladium, cobalt, platinum, and rhodium.

The predetermined conditions in the hydrogenation reaction are not particularly limited, and a reaction temperature is preferably from 100° C. to 300° C., more preferably from 150° C. to 280° C., still more preferably from 180° C. to 250° C., the supply pressure of hydrogen is preferably from 0.5 MPaG to 10 MPaG, more preferably from 1 MPaG to 8 MPaG, still more preferably from 2 MPaG to 7 MPaG, and a reaction time is preferably from 1 hour to 20 hours, more preferably from 2 hours to 15 hours, still more preferably from 3 hours to 10 hours.

The petroleum resin (A) may have a form of a copolymer as described above, and the difference in production process thereof as compared to the resin of PTL 1, which may have a form of a modified product, is as described below.

With regard to the copolymer, unlike the modified product, a step of producing a petroleum resin first and then conducting silane modification with a silane is not required, and hence the production process can be simplified. Accordingly, an economic advantage can be further expected.

### <Straight Asphalt>

The asphalt composition includes the petroleum resin (A) and straight asphalt.

The straight asphalt is used as an asphalt base oil.

Asphalt specified in Table 3 of JIS K 2207 or a mixture thereof may be used as the straight asphalt.

The penetration degree of the straight asphalt is preferably from 30 to 100, more preferably from 40 to 90, still more preferably from 50 to 80.

The penetration degree may be measured in conformity with Section 6.3 “Penetration Degree Test Method” of JIS K 2207.

### <Asphalt Composition>

The asphalt composition includes the petroleum resin (A) and the straight asphalt.

The content of the petroleum resin (A) in the asphalt composition is preferably 0.1 mass % or more and 5 mass % or less, more preferably 0.1 mass % or more and 3 mass % or less, still more preferably 0.15 mass % or more and 3 mass % or less, even still more preferably 0.3 mass % or more and 3 mass % or less from the viewpoint of improving the adhesion property between the asphalt composition and the aggregate.

The content of the straight asphalt in the asphalt composition is preferably from 70.00 mass % to 99.99 mass %, more preferably from 90 mass % to 99.90 mass %, still more preferably from 93 mass % to 99.90 mass % from the viewpoint of improving the adhesion property between the asphalt composition and the aggregate.

The asphalt composition may include various additives in addition to the petroleum resin (A) and the straight asphalt to the extent that the effect of the present invention is not inhibited. Examples of the additive include an antioxidant, an adhesion accelerator, an emulsifier, a chemical modifier, a fiber, a pigment, a rubber-based additive, a tackifier, and a regeneration additive.

When the additive is used, the content thereof in the asphalt composition is preferably 20 mass % or less, more preferably 10 mass % or less, still more preferably 5 mass % or less, still more preferably 3 mass % or less.

### <Method of Producing Asphalt Composition>

A method of producing the asphalt composition is not particularly limited, and for example, the asphalt composition is preferably formed as follows: the petroleum resin (A) is pulverized into a predetermined diameter or less; the pulverized petroleum resin (A) and the straight asphalt are then loaded into a vessel made of stainless steel at a predetermined ratio; and heating, stirring, and mixing are performed under predetermined conditions.

A stirring and mixing time can be shortened by pulverizing the petroleum resin (A) to a diameter of preferably 10 mm or less, more preferably 7 mm or less, still more preferably 5 mm or less in advance before the petroleum resin (A) and the straight asphalt are stirred and mixed.

The predetermined conditions in the stirring and mixing are not particularly limited, and the heating condition is preferably 80° C. or more, more preferably 100° C. or more, still more preferably 150° C. or more, the stirring condition is preferably from 500 rpm to 8,000 rpm, more preferably from 700 rpm to 7,000 rpm, still more preferably from 1,000 rpm to 5,000 rpm, and the stirring and mixing time is preferably from 3 minutes to 60 minutes, more preferably from 5 minutes to 45 minutes, still more preferably from 10 minutes to 30 minutes.

### <Asphalt Mixture>

An asphalt mixture according to one aspect of the first invention includes the asphalt composition of the first invention and the aggregate. The content of the asphalt composition is preferably from 0.1 mass % to 30 mass %, more preferably from 1 mass % to 20 mass %, more preferably from 1 mass % to 15 mass %, still more preferably from 1 mass % to 10 mass %, even still more preferably from 2 mass % to 7 mass %.

With regard to the asphalt mixture, an asphalt mixture having a desired property is obtained by adding aggregate having a predetermined particle diameter to the asphalt composition and mixing the materials at a predetermined revolution number. The temperature at the time of the mixing of the asphalt composition and the aggregate is preferably from about 150° C. to about 200° C.

### [Second Invention: Petroleum Resin (B)]

A petroleum resin (B) according to a second invention is described below.

The petroleum resin (B) is obtained by copolymerization of: a monomer containing at least one kind of cyclic olefin having an ethylenically unsaturated group selected from a C5 fraction, a C8 fraction, and a C9 fraction of cracked naphtha, and dicyclopentadiene; and a silane.

The petroleum resin (B) satisfies the following conditions (b1) and (b2):
(b1) the petroleum resin (B) contains 0.1 mass % or more and 10 mass % or less of silicon element in terms of silicon atoms; and
(b2) the petroleum resin (B) has a weight-average molecular weight (Mw) of 500 or more and 3,000 or less.

The above-mentioned physical properties of the petroleum resin (B) may be appropriately adjusted by the selection of a raw material monomer, the selection of a polymerization solvent, and the selection of a catalyst, the usage amounts thereof, a polymerization temperature, a reaction pressure, and other polymerization conditions.

According to the second invention, the following effect is exhibited. The petroleum resin (B) that can improve the water resistance of the asphalt mixture (mixture of the asphalt and the aggregate) by being added to the asphalt to extend the lifetime of an asphalt road can be provided. The reason for the effect is not necessarily clear, but is conceived to be as described below.

Typically, in the asphalt road, when moisture is present at an interface between the aggregate and the asphalt, the affinity between the hydroxy group on the surface of the aggregate and the moisture is larger than the affinity between the surface of the aggregate and the asphalt. Accordingly, the asphalt is peeled from the surface of the aggregate, and application of a load of an automobile or the like thereto leads to damage to the asphalt road. In contrast, when the petroleum resin (B) is added to the asphalt, the aggregate and the petroleum resin (B) are chemically bonded to each other by the reaction between the hydroxy group on the surface of the aggregate and a silane-containing group of the petroleum resin (B), and hence the affinity between the aggregate and the asphalt is improved, and the adhesion property between the aggregate and the asphalt is improved. At this time, even when the moisture is present in the vicinity of the surface of the aggregate, the aggregate and the petroleum resin (B) are bonded to each other by a chemical bond, and hence the asphalt is not peeled. Accordingly, it is conceived that the water resistance of the asphalt road is improved, and hence the durability thereof is improved because the adhesion property between the aggregate and the asphalt is maintained.

The above-mentioned mechanism with regard to the effect of the present invention is a presumption, and the mechanism is not limited thereto.

The petroleum resin (B) contains 0.1 mass % or more and 10 mass % or less, preferably 0.3 mass % or more, more preferably 0.4 mass % or more, still more preferably 0.5 mass % or more, and preferably less than 3.1 mass %, more preferably less than 1.7 mass %, still more preferably 1.0 mass % or less of silicon element in terms of silicon atoms. Herein, the silicon element is preferably derived from an organic silane structure.

When the concentration of the silicon element in the petroleum resin (B) is less than the above-mentioned ranges (less than 0.1 mass %), the petroleum resin (B) hardly reacts with the surface of the aggregate, and hence the water resistance of the asphalt mixture may become insufficient.

Meanwhile, when the concentration of the silicon element in the petroleum resin (B) is more than the above-mentioned ranges (more than 10 mass %), molecules of the petroleum resin (B) react with each other to increase the molecular weight thereof. Accordingly, the mixing performance with the asphalt is reduced, and hence the water resistance of the asphalt mixture may not be improved.

The concentration of the silicon element may be measured by ICP emission spectroscopy, and may be specifically determined by a method described in Examples.

In the case where the petroleum resin (B) is used as the asphalt composition, when the concentration of the silicon element in the petroleum resin (B) is more than 1.0 mass %, for example, molecules of the petroleum resin (B) may be cross-linked to each other under a condition, such as being exposed to high temperature in the presence of water, or being in the presence of an acid or an alkali. As a result, the improving effect on the water resistance may be reduced.

The petroleum resin (B) has a weight-average molecular weight (Mw) of 500 or more and 3,000 or less, preferably 700 or more, more preferably 1,000 or more, still more preferably 1,200 or more, even still more preferably 1,500 or more, and preferably 3,000 or less, more preferably 2,800 or less, still more preferably 2,500 or less.

When the weight-average molecular weight (Mw) of the petroleum resin (B) is less than the above-mentioned ranges (less than 500), the asphalt composition may have an insufficient hardness at normal temperature or may become brittle to have reduced strength, and hence the durability of an asphalt road may be reduced.

Meanwhile, when the weight-average molecular weight (Mw) of the petroleum resin (B) is more than the above-mentioned ranges (more than 3,000), the viscosity at the time of the mixing with asphalt at high temperature may be increased, and the mixing performance with the asphalt may be degraded. Accordingly, sufficient water resistance may not be exhibited.

In addition, the petroleum resin (B) has a molecular weight distribution (Mw/Mn) of preferably 5.0 or less, more preferably 4.0 or less, still more preferably 3.0 or less from the viewpoint of improving the adhesion property between the aggregate and the asphalt.

The weight-average molecular weight (Mw) and the number-average molecular weight (Mn) are each a molecular weight in terms of polystyrene. The molecular weights may each be measured by a gel permeation chromatograph (GPC) method, and may each be specifically determined by a method described in Examples.

The petroleum resin (B) preferably satisfies the following condition (b3):
(b3) the petroleum resin (B) has a softening point of from 70° C. to 150° C.

The petroleum resin (B) has a softening point of preferably from 70° C. to 150° C., more preferably from 80° C. to 140° C., still more preferably from 90° C. to 140° C. from the viewpoint of improving the adhesion property between the aggregate and the asphalt.

The softening point may be measured in conformity with JIS K 6863:1994.

The petroleum resin (B) preferably satisfies the following condition (b4):
(b4) the petroleum resin (B) has a bromine number of from 0.5 g/100 g to 30 g/100 g.

The petroleum resin (B) has a bromine number of preferably from 0.5 g/100 g to 30 g/100 g, more preferably from 1.0 g/100 g to 25 g/100 g, still more preferably from 2.0 g/100 g to 20 g/100 g from the viewpoint of improving the adhesion property between the aggregate and the asphalt.

The bromine number may be measured in conformity with JIS K 2605:1996.

The petroleum resin (B) includes a repeating unit derived from a monomer and a repeating unit derived from a silane, and is preferably obtained by copolymerization of a monomer and a silane.

### (Monomer)

The monomer for forming the petroleum resin (B) contains at least one kind of cyclic olefin having an ethylenically unsaturated group selected from a C5 fraction, a C8 fraction, and a C9 fraction of cracked naphtha, and a cyclopentadiene-based compound, preferably contains a cyclopentadiene-based compound, and more preferably contains dicyclopentadiene.

Further, a cyclopentadiene-based compound serving as a first raw material and a vinyl aromatic compound serving as a second raw material are preferably used as the monomers, and the first raw material may be used alone without the use of the second raw material.

Examples of the cyclopentadiene-based compound include cyclopentadiene, methylcyclopentadiene, ethylcyclopentadiene, and dimers and codimers thereof. Among them, dicyclopentadiene is preferred as the cyclopentadiene-based compound.

Examples of the vinyl aromatic compound include styrene, α-methylstyrene, β-methylstyrene, vinyltoluene, vinylxylene, indene, methylindene, and ethylindene. Among them, styrene is preferred as the vinyl aromatic compound.

The mixing ratio between the cyclopentadiene-based compound and the vinyl aromatic compound is not particularly limited, and the ratio “cyclopentadiene-based compound: vinyl aromatic compound” is preferably from 80:20 to 20:80, more preferably from 75:25 to 25:75 in terms of mass ratio.

### (Silane)

The silane for forming the petroleum resin (B) is not particularly limited, and preferably has a structure represented by the following formula (1):

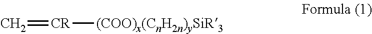

wherein
in the formula (1), R represents a hydrogen atom or a methyl group, “x” and “y” each represent 0 or 1, provided that when “x” represents 1, “y” represents 1, “n” represents an integer of from 1 to 12, preferably from 1 to 4, and R's each independently represent an alkoxy group having 1 to 12 carbon atoms (e.g., a methoxy, ethoxy, or butoxy group), an aryloxy group (e.g., a phenoxy group), an aralkyloxy group (e.g., a benzyloxy group), an aliphatic acyloxy group having 1 to 12 carbon atoms (e.g., a formyloxy, acetyloxy, or propanoyloxy group), an amino or substituted amino group (an alkylamino or arylamino group), or a lower alkyl group having 1 to 6 carbon atoms, provided that two or less of the three R′ groups are each an alkyl group.

In the formula (1), R preferably represents a hydrogen atom from the viewpoint of improving the adhesion property between the asphalt composition and the aggregate, “x” and/or “y” preferably represents 0, and “x” and “y” each more preferably represent 0.

In addition, in the formula (1), R's each represent preferably an alkoxy group having 1 to 12 carbon atoms (e.g., a methoxy, ethoxy, or butoxy group), more preferably an alkoxy group having 1 to 5 carbon atoms, still more preferably an alkoxy group having 1 to 3 carbon atoms from the viewpoint of improving the adhesion property between the asphalt composition and the aggregate.

The silane is preferably at least one kind selected from vinyltrimethoxysilane, vinyltriethoxysilane, and 3-(trimethoxysilyl) propyl methacrylate from the viewpoint of improving the adhesion property between the asphalt composition and the aggregate.

The petroleum resin (B) is preferably a hydrogenated product obtained by hydrogenation (hydrogen addition) from the viewpoint of improving the adhesion property between the asphalt composition and the aggregate. The hydrogenated product of the petroleum resin (B) may be a partially hydrogenated type in which the petroleum resin (B) is partially hydrogenated, or may be a completely hydrogenated type in which the petroleum resin (B) is completely hydrogenated.

The petroleum resin (B) may have a form of a copolymer as described above, and the difference in structure thereof as compared to the resin of PTL 1, which may have a form of a modified product, is as described below.

In the modified product, a radical attacks the petroleum resin and a silane is added to a decomposed moiety, and hence a modified moiety has a low molecular weight and Si is added to a low molecular weight side. Meanwhile, in the copolymer, monomers each have substantially equal copolymerizability, and hence Si is uniformly added.

That is, Si is uniformly added in the copolymer, and hence even when the content of Si is increased, a site where Si is locally present is not generated. As a result, a high content of Si can be achieved without causing gelation. Meanwhile, Si is nonuniformly added in the modified product, and hence a portion with a high Si concentration is present in a molecule (a site where Si is locally present is generated), the ratio of Si that effectively acts with a hydroxy group on the surface of the aggregate is reduced, and the probability of the presence of a molecule having no Si added thereto is increased. Accordingly, the improving effect on the water resistance is reduced.

Accordingly, a higher improving effect on the water resistance can be expected to be exhibited when the petroleum resin (B) is used for an asphalt mixture from the viewpoint that a higher content of Si can be achieved by the form of the copolymer than the form of the modified product.

### <Method of Producing Petroleum Resin (B)>

A method of producing the petroleum resin (B) is not particularly limited, and for example, the petroleum resin (B) is preferably formed as follows: the above-mentioned monomer, the above-mentioned silane, and a solvent for polymerization are supplied into a polymerization reaction vessel; and the above-mentioned monomer and the above-mentioned silane are subjected to a copolymerization reaction under predetermined conditions.

The usage amount of the silane is preferably from 0.1 part by mass to 80 parts by mass, more preferably from 0.5 part by mass to 50 parts by mass, still more preferably from 1 part by mass to 30 parts by mass with respect to 100 parts by mass of the monomer.

Herein, typical examples of the solvent for polymerization include an aromatic solvent, a naphthene-based solvent, and an aliphatic hydrocarbon-based solvent. Toluene, xylene, cyclohexane, methylcyclohexane, dimethylcyclohexane, and ethylcyclohexane are suitably used as specific examples of the solvent for polymerization.

The usage amount of the solvent for polymerization is preferably from 10 parts by mass to 300 parts by mass, more preferably from 20 parts by mass to 200 parts by mass, still more preferably from 30 parts by mass to 100 parts by mass with respect to 100 parts by mass of the monomer.

The predetermined conditions in the copolymerization reaction are not particularly limited, and a reaction temperature is preferably from 150° C. to 350° C., more preferably from 200° C. to 350° C., still more preferably from 230° C. to 300° C., a reaction pressure is preferably from 0 MPaG to 5 MPaG, more preferably from 0 MPaG to 3 MPaG, still more preferably from 0.1 MPaG to 2 MPaG, and a reaction time is preferably from 1 hour to 10 hours, more preferably from 1 hour to 8 hours, still more preferably from 1 hour to 5 hours. “G” in “MPaG” refers to a gauge pressure.

In addition, a method of producing the petroleum resin (B) as a hydrogenated product is not particularly limited, and for example, the hydrogenated product of the petroleum resin (B) is preferably formed as follows: in a hydrogenation reaction vessel, the petroleum resin (B) is dissolved in a hydrogenation solvent; and hydrogen is added under predetermined conditions in the presence of a hydrogenation reaction catalyst as required to perform a hydrogenation reaction.

Herein, examples of the hydrogenation solvent include cyclohexane, methylcyclohexane, dimethylcyclohexane, ethylcyclohexane, and tetrahydrofuran.

The usage amount of the hydrogenation solvent is preferably from 30 parts by mass to 300 parts by mass, more preferably from 50 parts by mass to 250 parts by mass, still more preferably from 70 parts by mass to 150 parts by mass with respect to 100 parts by mass of the petroleum resin (B).

In addition, an example of the hydrogenation reaction catalyst is a catalyst containing at least one kind of metal component selected from nickel, palladium, cobalt, platinum, and rhodium.

The predetermined conditions in the hydrogenation reaction are not particularly limited, and a reaction temperature is preferably from 100° C. to 300° C., more preferably from 150° C. to 280° C., still more preferably from 180° C. to 250° C., the supply pressure of hydrogen is preferably from 0.5 MPaG to 10 MPaG, more preferably from 1 MPaG to 8 MPaG, still more preferably from 2 MPaG to 7 MPaG, and a reaction time is preferably from 1 hour to 20 hours, more preferably from 2 hours to 15 hours, still more preferably from 3 hours to 10 hours.

The petroleum resin (B) may have a form of a copolymer as described above, and the difference in production process thereof as compared to the resin of PTL 1, which may have a form of a modified product, is as described below.

With regard to the copolymer, unlike the modified product, a step of producing a petroleum resin first and then conducting silane modification with a silane is not required, and hence the production process can be simplified. Accordingly, an economic advantage can be further expected.

### <Straight Asphalt>

The petroleum resin (B) may be used by being incorporated into the asphalt composition.

When the asphalt composition includes the petroleum resin (B) and straight asphalt, the straight asphalt is used as an asphalt base oil.

Asphalt specified in Table 3 of JIS K 2207 or a mixture thereof may be used as the straight asphalt.

The penetration degree of the straight asphalt is preferably from 30 to 100, more preferably from 40 to 90, still more preferably from 50 to 80.

The penetration degree may be measured in conformity with Section 6.3 “Penetration Degree Test Method” of JIS K 2207.

### <Asphalt Composition>

When the asphalt composition includes the petroleum resin (B) and the straight asphalt, the content of the petroleum resin (B) in the asphalt composition is preferably 0.1 mass % or more and 5 mass % or less, more preferably 0.1 mass % or more and 3 mass % or less, still more preferably 0.15 mass % or more and 3 mass % or less, even still more preferably 0.3 mass % or more and 3 mass % or less from the viewpoint of improving the adhesion property between the asphalt composition and the aggregate.

The content of the straight asphalt in the asphalt composition is preferably from 70.00 mass % to 99.99 mass %, more preferably from 90 mass % to 99.90 mass %, still more preferably from 93 mass % to 99.90 mass % from the viewpoint of improving the adhesion property between the asphalt composition and the aggregate.

The asphalt composition may include various additives in addition to the petroleum resin (B) and the straight asphalt to the extent that the effect of the present invention is not inhibited. Examples of the additive include an antioxidant, an adhesion accelerator, an emulsifier, a chemical modifier, a fiber, a pigment, a rubber-based additive, a tackifier, and a regeneration additive.

When the additive is used, the content thereof in the asphalt composition is preferably 20 mass % or less, more preferably 10 mass % or less, still more preferably 5 mass % or less, still more preferably 3 mass % or less.

### <Method of Producing Asphalt Composition>

A method of producing the asphalt composition is not particularly limited, and for example, the asphalt composition is preferably formed as follows: the petroleum resin (B) is pulverized into a predetermined diameter or less; the pulverized petroleum resin (B) and the straight asphalt are then loaded into a vessel made of stainless steel at a predetermined ratio; and heating, stirring, and mixing are performed under predetermined conditions.

A stirring and mixing time can be shortened by pulverizing the petroleum resin (B) to a diameter of preferably 10 mm or less, more preferably 7 mm or less, still more preferably 5 mm or less in advance before the petroleum resin (B) and the straight asphalt are stirred and mixed.

The predetermined conditions in the stirring and mixing are not particularly limited, and the heating condition is preferably 80° C. or more, more preferably 100° C. or more, still more preferably 150° C. or more, the stirring condition is preferably from 500 rpm to 8,000 rpm, more preferably from 700 rpm to 7,000 rpm, still more preferably from 1,000 rpm to 5,000 rpm, and the stirring and mixing time is preferably from 3 minutes to 60 minutes, more preferably from 5 minutes to 45 minutes, still more preferably from 10 minutes to 30 minutes.

### <Asphalt Mixture>

An asphalt mixture according to one aspect of the second invention includes the asphalt composition including the petroleum resin (B) of the second invention and the aggregate. The content of the asphalt composition is preferably from 0.1 mass % to 30 mass %, more preferably from 1 mass % to 20 mass %, more preferably from 1 mass % to 15 mass %, still more preferably from 1 mass % to 10 mass %, even still more preferably from 2 mass % to 7 mass %.

With regard to the asphalt mixture, an asphalt mixture having a desired property is obtained by adding aggregate having a predetermined particle diameter to the asphalt composition and mixing the materials at a predetermined revolution number. The temperature at the time of the mixing of the asphalt composition and the aggregate is preferably from about 150° C. to about 200° C.

### [Third Invention: Hydrogenated Petroleum Resin (C)]

A hydrogenated petroleum resin (C) according to a third invention is described below.

The hydrogenated petroleum resin (C) is obtained by copolymerization of: a monomer containing at least one kind of cyclic olefin having an ethylenically unsaturated group selected from a C5 fraction, a C8 fraction, and a C9 fraction of cracked naphtha, and a cyclopentadiene-based compound; and a silane.

The hydrogenated petroleum resin (C) satisfies the following conditions (c1) and (c2):
(c1) the hydrogenated petroleum resin (C) contains 0.1 mass % or more and 10 mass % or less of silicon element in terms of silicon atoms; and
(c2) the hydrogenated petroleum resin (C) has a weight-average molecular weight (Mw) of 500 or more and 3,000 or less.

The above-mentioned physical properties of the hydrogenated petroleum resin (C) may be appropriately adjusted by the selection of a raw material monomer, the selection of a polymerization solvent, and the selection of a catalyst, the usage amounts thereof, a polymerization temperature, a reaction pressure, and other polymerization conditions.

According to the third invention, the following effect is exhibited. The petroleum resin (C) that can improve the water resistance of the asphalt mixture (mixture of the asphalt and the aggregate) by being added to the asphalt to extend the lifetime of an asphalt road can be provided. The reason for the effect is not necessarily clear, but is conceived to be as described below.

Typically, in the asphalt road, when moisture is present at an interface between the aggregate and the asphalt, the affinity between the hydroxy group on the surface of the aggregate and the moisture is larger than the affinity between the surface of the aggregate and the asphalt. Accordingly, the asphalt is peeled from the surface of the aggregate, and the application of a load of an automobile or the like thereto leads to damage to the asphalt road. In contrast, when the hydrogenated petroleum resin (C) is added to the asphalt, the aggregate and the hydrogenated petroleum resin (C) are chemically bonded to each other by the reaction between the hydroxy group on the surface of the aggregate and a silane-containing group of the hydrogenated petroleum resin (C), and hence the affinity between the aggregate and the asphalt is improved, and the adhesion property between the aggregate and the asphalt is improved. At this time, even when the moisture is present in the vicinity of the surface of the aggregate, the aggregate and the hydrogenated petroleum resin (C) are bonded to each other by a chemical bond, and hence the asphalt is not peeled. Accordingly, it is conceived that the water resistance of the asphalt road is improved, and hence the durability thereof is improved because the adhesion property between the aggregate and the asphalt is maintained.

The above-mentioned mechanism with regard to the effect of the present invention is a presumption, and the mechanism is not limited thereto.

The hydrogenated petroleum resin (C) contains 0.1 mass % or more and 10 mass % or less, preferably 0.3 mass % or more, more preferably 0.4 mass % or more, still more preferably 0.5 mass % or more, and preferably 3.1 mass % or less, more preferably 1.7 mass % or less, still more preferably 1.0 mass % or less of silicon element in terms of silicon atoms. Herein, the silicon element is preferably derived from an organic silane structure.

When the concentration of the silicon element in the hydrogenated petroleum resin (C) is less than the above-mentioned ranges (less than 0.1 mass %), the hydrogenated petroleum resin (C) hardly reacts with the surface of the aggregate, and hence the water resistance of the asphalt mixture may become insufficient.

Meanwhile, when the concentration of the silicon element in the hydrogenated petroleum resin (C) is more than the above-mentioned ranges (more than 10 mass %), molecules of the hydrogenated petroleum resin (C) react with each other to increase the molecular weight thereof. Accordingly, the mixing performance with the asphalt is reduced, and hence the water resistance of the asphalt mixture may not be improved.

The concentration of the silicon element may be measured by ICP emission spectroscopy, and may be specifically determined by a method described in Examples.

In the case where the hydrogenated petroleum resin (C) is used as the asphalt composition, when the concentration of the silicon element in the hydrogenated petroleum resin (C) is more than 1.0 mass %, for example, molecules of the hydrogenated petroleum resin (C) may be cross-linked to each other under a condition, such as being exposed to high temperature in the presence of water, or being in the presence of an acid or an alkali. As a result, the improving effect on the water resistance may be reduced.

The hydrogenated petroleum resin (C) has a weight-average molecular weight (Mw) of 500 or more and 3,000 or less, preferably 700 or more, more preferably 1,000 or more, still more preferably 1,200 or more, even still more preferably 1,500 or more, and preferably 3,000 or less, more preferably 2,800 or less, still more preferably 2,500 or less.

When the weight-average molecular weight (Mw) of the hydrogenated petroleum resin (C) is less than the above-mentioned ranges (less than 500), the asphalt composition may have an insufficient hardness at normal temperature or may become brittle to have reduced strength, and hence the durability of an asphalt road may be reduced.

Meanwhile, when the weight-average molecular weight (Mw) of the hydrogenated petroleum resin (C) is more than the above-mentioned ranges (more than 3,000), the viscosity thereof at the time of mixing with asphalt at high temperature may be increased, and the mixing performance thereof with the asphalt may be degraded. Accordingly, sufficient water resistance may not be exhibited.

In addition, the hydrogenated petroleum resin (C) has a molecular weight distribution (Mw/Mn) of preferably 5.0 or less, more preferably 4.0 or less, still more preferably 3.0 or less from the viewpoint of improving the adhesion property between the aggregate and the asphalt.

The weight-average molecular weight (Mw) and the number-average molecular weight (Mn) are each a molecular weight in terms of polystyrene. The molecular weights may each be measured by a gel permeation chromatograph (GPC) method, and may each be specifically determined by a method described in Examples.

The hydrogenated petroleum resin (C) preferably satisfies the following condition (c3):
(c3) the hydrogenated petroleum resin (C) has a softening point of from 70° C. to 150° C.

The hydrogenated petroleum resin (C) has a softening point of preferably from 70° C. to 150° C., more preferably from 80° C. to 140° C., still more preferably from 90° C. to 140° C. from the viewpoint of improving the adhesion property between the aggregate and the asphalt.

The softening point may be measured in conformity with JIS K 6863:1994.

The hydrogenated petroleum resin (C) preferably satisfies the following condition (c4):
(c4) the hydrogenated petroleum resin (C) has a bromine number of from 0.5 g/100 g to 30 g/100 g.

The hydrogenated petroleum resin (C) has a bromine number of preferably from 0.5 g/100 g to 30 g/100 g, more preferably from 1.0 g/100 g to 25 g/100 g, still more preferably from 2.0 g/100 g to 20 g/100 g from the viewpoint of improving the adhesion property between the aggregate and the asphalt.

The bromine number may be measured in conformity with JIS K 2605:1996.

The hydrogenated petroleum resin (C) includes a repeating unit derived from a monomer and a repeating unit derived from a silane, and is preferably obtained by copolymerization of a monomer and a silane.

### (Monomer)

The monomer for forming the hydrogenated petroleum resin (C) contains at least one kind of cyclic olefin having an ethylenically unsaturated group selected from a C5 fraction, a C8 fraction, and a C9 fraction of cracked naphtha, and a cyclopentadiene-based compound, preferably contains a cyclopentadiene-based compound, and more preferably contains dicyclopentadiene.

Further, a cyclopentadiene-based compound serving as a first raw material and a vinyl aromatic compound serving as a second raw material are preferably used as the monomers, and the first raw material may be used alone without the use of the second raw material.

Examples of the cyclopentadiene-based compound include cyclopentadiene, methylcyclopentadiene, ethylcyclopentadiene, and dimers and codimers thereof. Among them, dicyclopentadiene is preferred as the cyclopentadiene-based compound.

Examples of the vinyl aromatic compound include styrene, α-methylstyrene, β-methylstyrene, vinyltoluene, vinylxylene, indene, methylindene, and ethylindene. Among them, styrene is preferred as the vinyl aromatic compound.

The mixing ratio between the cyclopentadiene-based compound and the vinyl aromatic compound is not particularly limited, and the ratio “cyclopentadiene-based compound: vinyl aromatic compound” is preferably from 80:20 to 20:80, more preferably from 75:25 to 25:75 in terms of mass ratio.

### (Silane)

The silane for forming the hydrogenated petroleum resin (C) is not particularly limited, and preferably has a structure represented by the following formula (1):

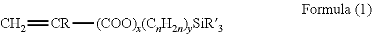

wherein
in the formula (1), R represents a hydrogen atom or a methyl group, “x” and “y” each represent 0 or 1, provided that when “x” represents 1, “y” represents 1, “n” represents an integer of from 1 to 12, preferably from 1 to 4, and R's each independently represent an alkoxy group having 1 to 12 carbon atoms (e.g., a methoxy, ethoxy, or butoxy group), an aryloxy group (e.g., a phenoxy group), an aralkyloxy group (e.g., a benzyloxy group), an aliphatic acyloxy group having 1 to 12 carbon atoms (e.g., a formyloxy, acetyloxy, or propanoyloxy group), an amino or substituted amino group (an alkylamino or arylamino group), or a lower alkyl group having 1 to 6 carbon atoms, provided that two or less of the three R′ groups are each an alkyl group.

In the formula (1), R preferably represents a hydrogen atom from the viewpoint of improving the adhesion property between the asphalt composition and the aggregate, “x” and/or “y” preferably represent 0, “x” and “y” each more preferably represent 0.

In addition, in the formula (1), R's each represent preferably an alkoxy group having 1 to 12 carbon atoms (e.g., a methoxy, ethoxy, or butoxy group), more preferably an alkoxy group having 1 to 5 carbon atoms, still more preferably an alkoxy group having 1 to 3 carbon atoms from the viewpoint of improving the adhesion property between the asphalt composition and the aggregate.

The silane is preferably at least one kind selected from vinyltrimethoxysilane, vinyltriethoxysilane, and 3-(trimethoxysilyl) propyl methacrylate from the viewpoint of improving the adhesion property between the asphalt composition and the aggregate.

The hydrogenated petroleum resin (C) may have a form of a copolymer as described above, and the difference in structure thereof as compared to the resin of PTL 1, which may have a form of a modified product, is as described below.

In the modified product, a radical attacks the hydrogenated petroleum resin and a silane is added to a decomposed moiety, and hence a modified moiety has a low molecular weight and Si is added to a low molecular weight side. Meanwhile, in the copolymer, monomers each have substantially equal copolymerizability, and hence Si is uniformly added.

That is, Si is uniformly added in the copolymer, and hence even when the content of Si is increased, a site where Si is locally present is not generated. As a result, a high content of Si can be achieved without causing gelation. Meanwhile, Si is nonuniformly added in the modified product, and hence a portion with a high Si concentration is present in a molecule (a site where Si is locally present is generated), the ratio of Si that effectively acts with a hydroxy group on the surface of the aggregate is reduced, and the probability of the presence of a molecule having no Si added thereto is increased. Accordingly, the improving effect on the water resistance is reduced.

Accordingly, a higher improving effect on the water resistance can be expected to be exhibited when the hydrogenated petroleum resin (C) is used for an asphalt mixture from the viewpoint that a higher content of Si can be achieved by the form of the copolymer than the form of the modified product.

### <Method of Producing Petroleum Resin for Forming Hydrogenated Petroleum Resin (C)>

A method of producing a petroleum resin for forming the hydrogenated petroleum resin (C) is not particularly limited, and for example, the petroleum resin is preferably formed as follows: the above-mentioned monomer, the above-mentioned silane, and a solvent for polymerization are supplied into a polymerization reaction vessel; and the above-mentioned monomer and the above-mentioned silane are subjected to a copolymerization reaction under predetermined conditions.

The usage amount of the silane is preferably from 0.1 part by mass to 80 parts by mass, more preferably from 0.5 part by mass to 50 parts by mass, still more preferably from 1 part by mass to 30 parts by mass with respect to 100 parts by mass of the monomer.

Herein, typical examples of the solvent for polymerization include an aromatic solvent, a naphthene-based solvent, and an aliphatic hydrocarbon-based solvent. Toluene, xylene, cyclohexane, methylcyclohexane, dimethylcyclohexane, and ethylcyclohexane are suitably used as specific examples of the solvent for polymerization.

The usage amount of the solvent for polymerization is preferably from 10 parts by mass to 300 parts by mass, more preferably from 20 parts by mass to 200 parts by mass, still more preferably from 30 parts by mass to 100 parts by mass with respect to 100 parts by mass of the monomer.

The predetermined conditions in the copolymerization reaction are not particularly limited, and a reaction temperature is preferably from 150° C. to 350° C., more preferably from 200° C. to 350° C., still more preferably from 230° C. to 300° C., a reaction pressure is preferably from 0 MPaG to 5 MPaG, more preferably from 0 MPaG to 3 MPaG, still more preferably from 0.1 MPaG to 2 MPaG, and a reaction time is preferably from 1 hour to 10 hours, more preferably from 1 hour to 8 hours, still more preferably from 1 hour to 5 hours. “G” in “MPaG” refers to a gauge pressure.

In addition, a method of producing the hydrogenated petroleum resin (C) by hydrogenating the petroleum resin is not particularly limited, and for example, the hydrogenated petroleum resin (C) is preferably formed as follows: in a hydrogenation reaction vessel, the above-mentioned petroleum resin is dissolved in a hydrogenation solvent; and hydrogen is added under predetermined conditions in the presence of a hydrogenation reaction catalyst as required to perform a hydrogenation reaction.

Herein, examples of the hydrogenation solvent include cyclohexane, methylcyclohexane, dimethylcyclohexane, ethylcyclohexane, and tetrahydrofuran.

The usage amount of the hydrogenation solvent is preferably from 30 parts by mass to 300 parts by mass, more preferably from 50 parts by mass to 250 parts by mass, still more preferably from 70 parts by mass to 150 parts by mass with respect to 100 parts by mass of the petroleum resin.

In addition, an example of the hydrogenation reaction catalyst is a catalyst containing at least one kind of metal component selected from nickel, palladium, cobalt, platinum, and rhodium.

The predetermined conditions in the hydrogenation reaction are not particularly limited, and a reaction temperature is preferably from 100° C. to 300° C., more preferably from 150° C. to 280° C., still more preferably from 180° C. to 250° C., the supply pressure of hydrogen is preferably from 0.5 MPaG to 10 MPaG, more preferably from 1 MPaG to 8 MPaG, still more preferably from 2 MPaG to 7 MPaG, and a reaction time is preferably from 1 hour to 20 hours, more preferably from 2 hours to 15 hours, still more preferably from 3 hours to 10 hours.

The hydrogenated petroleum resin (C) may have a form of a copolymer as described above, and the difference in production process thereof as compared to the resin of PTL 1, which may have a form of a modified product, is as described below.

With regard to the copolymer, unlike the modified product, a step of producing a petroleum resin first and then conducting silane modification with a silane is not required, and hence the production process can be simplified. Accordingly, an economic advantage can be further expected.

### <Straight Asphalt>

The hydrogenated petroleum resin (C) may be used by being incorporated into the asphalt composition.

When the asphalt composition includes the hydrogenated petroleum resin (C) and the straight asphalt, the straight asphalt is used as an asphalt base oil.

Asphalt specified in Table 3 of JIS K 2207 or a mixture thereof may be used as the straight asphalt.

The penetration degree of the straight asphalt is preferably from 30 to 100, more preferably from 40 to 90, still more preferably from 50 to 80.

The penetration degree may be measured in conformity with Section 6.3 “Penetration Degree Test Method” of JIS K 2207.

### <Asphalt Composition>

When the asphalt composition includes the hydrogenated petroleum resin (C) and the straight asphalt, the content of the hydrogenated petroleum resin (C) in the asphalt composition is preferably 0.1 mass % or more and 5 mass % or less, more preferably 0.1 mass % or more and 3 mass % or less, still more preferably 0.15 mass % or more and 3 mass % or less, even still more preferably 0.3 mass % or more and 3 mass % or less from the viewpoint of improving the adhesion property between the asphalt composition and the aggregate.

The content of the straight asphalt in the asphalt composition is preferably from 70.00 mass % to 99.99 mass %, more preferably from 90 mass % to 99.90 mass %, still more preferably from 93 mass % to 99.90 mass % from the viewpoint of improving the adhesion property between the asphalt composition and the aggregate.

The asphalt composition may include various additives in addition to the hydrogenated petroleum resin (C) and the straight asphalt to the extent that the effect of the present invention is not inhibited. Examples of the additive include an antioxidant, an adhesion accelerator, an emulsifier, a chemical modifier, a fiber, a pigment, a rubber-based additive, a tackifier, and a regeneration additive.

When the additive is used, the content thereof in the asphalt composition is preferably 20 mass % or less, more preferably 10 mass % or less, still more preferably 5 mass % or less, still more preferably 3 mass % or less.

<Method of producing Asphalt Composition>

A method of producing the asphalt composition is not particularly limited, and for example, the asphalt composition is preferably formed as follows: the hydrogenated petroleum resin (C) is pulverized into a predetermined diameter or less; the pulverized hydrogenated petroleum resin (C) and the straight asphalt are then loaded into a vessel made of stainless steel at a predetermined ratio; and heating, stirring, and mixing are performed under predetermined conditions.

A stirring and mixing time can be shortened by pulverizing the hydrogenated petroleum resin (C) to a diameter of preferably 10 mm or less, more preferably 7 mm or less, still more preferably 5 mm or less in advance before the hydrogenated petroleum resin (C) and the straight asphalt are stirred and mixed.

The predetermined conditions in the stirring and mixing are not particularly limited, and the heating condition is preferably 80° C. or more, more preferably 100° C. or more, still more preferably 150° C. or more, the stirring condition is preferably from 500 rpm to 8,000 rpm, more preferably from 700 rpm to 7,000 rpm, still more preferably from 1,000 rpm to 5,000 rpm, and the stirring and mixing time is preferably from 3 minutes to 60 minutes, more preferably from 5 minutes to 45 minutes, still more preferably from 10 minutes to 30 minutes.

### <Asphalt Mixture>

An asphalt mixture according to one aspect of the third invention includes the asphalt composition including the hydrogenated petroleum resin (C) of the third invention and the aggregate. The content of the asphalt composition is preferably from 0.1 mass % to 30 mass %, more preferably from 1 mass % to 20 mass %, more preferably from 1 mass % to 15 mass %, still more preferably from 1 mass % to 10 mass %, even still more preferably from 2 mass % to 7 mass %.

With regard to the asphalt mixture, an asphalt mixture having a desired property is obtained by adding aggregate having a predetermined particle diameter to the asphalt composition and mixing the materials at a predetermined revolution number. The temperature at the time of the mixing of the asphalt composition and the aggregate is preferably from about 150° C. to about 200° C.

### EXAMPLES

Next, the first, second, and third inventions are described in more detail by way of Examples, but the first, second, and third inventions are by no means limited to these examples.

### [Concentration of Silicon Element]

0.1 Gram of a petroleum resin or a hydrogenated petroleum resin produced in each example was heated in an electric furnace at 550° C. for 12 hours, and a measurement solution was prepared by alkali fusion of an ash content. ICP emission spectroscopic analysis was performed with an ICP emission spectrometer 720-ES (manufactured by Agilent Technologies, Inc., “720-ES”) to determine the concentration of silicon element.

### [Weight-Average Molecular Weight (Mw)]

The weight-average molecular weight (Mw) of the petroleum resin or the hydrogenated petroleum resin produced in each example was determined by a gel permeation chromatography (GPC) method. The weight-average molecular weight (Mw) was measured by using the following apparatus and conditions, and was determined as a molecular weight in terms of polystyrene.

### <GPC Measurement Apparatus>

Device: “HLC-8321GPC/HT” manufactured by Tosoh Corporation
Detector: RI detector
Column: 2 columns of “TOSOH GMHHR-H(S) HT” manufactured by Tosoh Corporation

### <Measurement Conditions>

Solvent: 1,2,4-trichlorobenzene
Measurement temperature: 145° C.
Flow rate: 1.0 mL/min
Sample concentration: 0.5 mg/mL
Injection amount: 300 μL
Calibration curve: produced with a PS standard substance
Molecular weight conversion: calculated by a Universal Calibration method
Analysis program: 8321GPC-WS

### [Softening Point]

The softening point of the petroleum resin or the hydrogenated petroleum resin produced in each example was measured in conformity with JIS K 6863:1994.

### [Bromine Number]

The bromine number of the petroleum resin or the hydrogenated petroleum resin produced in each example was measured in conformity with JIS K 2605:1996.

### [Evaluation of Asphalt Composition]

No. 6 crushed stone of hard sandstone aggregate was washed with water, and was dried at 170° C. for 1 hour or more. Next, 5.5 g±0.5 g of an asphalt composition was added to 100 g±0.5 g of the dried hard sandstone aggregate. While the resultant was dried on a hot plate at a temperature of from 160° C. to 180° C., the resultant was mixed and stirred for about 2 minutes to about 3 minutes. Thus, an asphalt mixture was produced, and 10 samples were selected therefrom. Next, the selected asphalt mixture was loaded into 100 mL of a 1.0 mol/L aqueous solution of sodium carbonate. After that, the aqueous solution was heated on the hot plate, and the heating was performed for 1 minute after the temperature had reached 90° C. After cooling, an upper surface of the asphalt mixture was visually observed. A peeled area ratio of the asphalt covering the surface of the aggregate was calculated, and the asphalt composition was evaluated by the following criteria.
A: The peeled area ratio was 50% or less.
B: The peeled area ratio was more than 50% and 70% or less.
C: The peeled area ratio was more than 70%.

Herein, the asphalt composition may be evaluated as follows: as the peeled area ratio of the upper surface of the asphalt mixture becomes smaller, the peeling of asphalt is suppressed more, and the water resistance of the asphalt mixture is more excellent.

### Comparative Production Example 1: Hydrogenated Petroleum Resin

180 Grams of xylene was loaded into a 1 L autoclave, and a temperature in the autoclave was increased to 260° C. Next, a mixture of 100 g of dicyclopentadiene and 100 g of styrene was loaded thereinto over 3 hours. A polymerization reaction was performed while the temperature was maintained for an additional 75 minutes. Thus, a polymer mixture was obtained.

After that, xylene was recovered from the resultant polymer mixture, and then the mixture was maintained at 20 mmHg for 2 hours so that a low-boiling point product was evaporated therefrom. Thus, a petroleum resin was obtained.

180 Grams of the resultant petroleum resin, 180 g of ethylcyclohexane, and 4 g of a nickel-based catalyst (N110 series) manufactured by JGC Catalysts and Chemicals Ltd. were loaded into a 1 L autoclave. Hydrogen was loaded thereinto so that its pressure became 5 MPa. A temperature in the autoclave was increased from room temperature to 230° C. After that, while the hydrogen pressure was kept at 5 MPa, a hydrogenation reaction was performed for 8 hours. Thus, a hydrogenated petroleum resin was obtained.

### Production Example 1: Petroleum Resin (A1)

180 Grams of xylene was loaded into a 1 L autoclave, and 236 g of dicyclopentadiene, 108 g of styrene, and 72 g of vinyltrimethoxysilane (manufactured by Tokyo Chemical Industry Co., Ltd.) were loaded thereinto. After purging with nitrogen, a pressure in the autoclave was adjusted to 0.15 MPa. A temperature in the autoclave was increased to 278° C., and a polymerization reaction was performed while the temperature was maintained for 3 hours. Thus, a polymer mixture was obtained.

After that, xylene was recovered from the resultant polymer mixture, and then the mixture was maintained at 20 mmHg for 2 hours so that a low-boiling point product was evaporated therefrom. Thus, a petroleum resin (A1) was obtained.

### Production Example 2: Hydrogenated Petroleum Resin (A2)

180 Grams of the petroleum resin obtained in Production Example 1, 180 g of ethylcyclohexane, and 8 g of a nickel-based catalyst (N110 series) manufactured by JGC Catalysts and Chemicals Ltd. were loaded into a 1 L autoclave. Hydrogen was loaded thereinto so that its pressure became 5 MPa. A temperature in the autoclave was increased from room temperature to 230° C. After that, while the hydrogen pressure was kept at 5 MPa, a hydrogenation reaction was performed for 8 hours. Thus, a hydrogenated petroleum resin (A2) was obtained.

### Production Example 3: Petroleum Resin (A3)

180 Grams of xylene was loaded into a 1 L autoclave, and 236 g of dicyclopentadiene, 108 g of styrene, and 11 g of vinyltrimethoxysilane (manufactured by Tokyo Chemical Industry Co., Ltd.) were loaded thereinto. After purging with nitrogen, a pressure in the autoclave was adjusted to 0.15 MPa. A temperature in the autoclave was increased to 278° C., and a polymerization reaction was performed while the temperature was maintained for 3 hours. Thus, a polymer mixture was obtained.

After that, xylene was recovered from the resultant polymer mixture, and then the mixture was maintained at 20 mmHg for 2 hours so that a low-boiling point product was evaporated therefrom. Thus, a petroleum resin (A3) was obtained.

### Production Example 4: Hydrogenated Petroleum Resin (A4)

180 Grams of the petroleum resin (A3) obtained in Production Example 3, 180 g of ethylcyclohexane, and 8 g of a nickel-based catalyst (N110 series) manufactured by JGC Catalysts and Chemicals Ltd. were loaded into a 1 L autoclave. Hydrogen was loaded thereinto so that its pressure became 5 MPa. A temperature in the autoclave was increased from room temperature to 230° C. After that, while the hydrogen pressure was kept at 5 MPa, a hydrogenation reaction was performed for 8 hours. Thus, a hydrogenated petroleum resin (A4) was obtained.

### Production of Asphalt Composition

### Example 1

The petroleum resin (A1) obtained in Production Example 1 was pulverized into a diameter of 5 mm or less. Then, the petroleum resin (A1) and straight asphalt (manufactured by Idemitsu Kosan Co., Ltd., penetration degree: 72) were loaded into a 200 mL cylindrical vessel made of stainless steel at a blending ratio shown in Table 1 so that a total amount thereof became 50 g. The materials were stirred and mixed with a stirring apparatus and a heating mantle for about 15 minutes under the conditions of 160° C. or more and a revolution number of 2,000 rpm or more and 4,000 rpm or less. Thus, an asphalt composition was obtained.

### Example 2

An asphalt composition was obtained in the same manner as in Example 1 except that the petroleum resin (A1) obtained in Production Example 1 was changed to the hydrogenated petroleum resin (A2) obtained in Production Example 2.

### Example 3

An asphalt composition was obtained in the same manner as in Example 1 except that the petroleum resin (A1) obtained in Production Example 1 was changed to the petroleum resin (A3) obtained in Production Example 3.

### Example 4

An asphalt composition was obtained in the same manner as in Example 1 except that the petroleum resin (A1) obtained in Production Example 1 was changed to the hydrogenated petroleum resin (A4) obtained in Production Example 4.

### Comparative Example 1

An asphalt composition was obtained in the same manner as in Example 1 except that: the petroleum resin (A1) obtained in Production Example 1 was changed to the hydrogenated petroleum resin obtained in Comparative Production Example 1; and the blending ratio was changed to that shown in Table 1.

### Comparative Example 2

An asphalt composition was obtained in the same manner as in Example 1 except that no petroleum resin was used.

The evaluation results of the asphalt composition according to the first invention produced in each example are shown in Table 1.

The evaluation results of the petroleum resin (B) according to the second invention produced in each example are shown in Table 2.

The evaluation results of the hydrogenated petroleum resin (C) according to the third invention produced in each example are shown in Table 3.

TABLE 1
Asphalt Composition according to First Invention

| | | | | | | Comparative | Comparative |
|---|---|---|---|---|---|---|---|
| | | Example 1 | Example 2 | Example 3 | Example 4 | Example 1 | Example 2 |
| Petroleum | Kind | Production | Production | Production | Production | Comparative | — |
| resin or | | Example 1: | Example 2: | Example 3: | Example 4: | Production | |
| hydrogenated | | Petroleum | Hydrogenated | Petroleum | Hydrogenated | Example 1: | |
| petroleum | | resin | petroleum | resin | petroleum | Hydrogenated | |
| resin | | | resin | | resin | petroleum | |
| | | | | | | resin | |
| | Silicon element | 3.0 | 2.9 | 0.5 | 0.5 | 0 | — |
| | concentration | | | | | | |
| | (mass %) | | | | | | |
| | Weight-average | 1,400 | 1,900 | 1,600 | 2,400 | 1,100 | — |
| | molecular weight | | | | | | |
| | (Mw) | | | | | | |
| | Molecular weight | 2.3 | 2.8 | 2.8 | 3.9 | 2.1 | |
| | distribution | | | | | | |
| | (Mw/Mn) | | | | | | |
| | Bromine number | 14.3 | 2.5 | 16.5 | 2.5 | 2.5 | — |
| | (g/100 g) | | | | | | |
| | Softening point | 100.9 | 136.6 | 94.9 | 119.2 | 102.5 | |
| | (° C.) | | | | | | |
| | Content (mass %) | 0.5 | 0.5 | 0.5 | 0.5 | 1 | — |
| Asphalt | Kind | Straight | Straight | Straight | Straight | Straight | Straight |
| | | asphalt | asphalt | asphalt | asphalt | asphalt | asphalt |
| | Content (mass %) | 99.5 | 99.5 | 99.5 | 99.5 | 99 | 100 |
| Evaluation of | Peeled area | 20 | 50 | 40 | 50 | 95 | 100 |
| asphalt | ratio (%) | | | | | | |
| composition | Result | A | A | A | A | C | C |

From the results shown in Table 1, it was recognized that each of the asphalt compositions according to the first invention of Examples 1 to 4 suppressed the peeling of the asphalt from the aggregate and improved the water resistance of the asphalt mixture as compared to each of the asphalt compositions of Comparative Examples 1 and 2.

TABLE 2
Petroleum Resin (B) according to Second Invention

| | | | | Comparative | Comparative |
|---|---|---|---|---|---|
| | | Example 3 | Example 4 | Example 1 | Example 2 |
| Petroleum resin | Kind | Production | Production | Comparative | — |
| or hydrogenated | | Example 3: | Example 4: | Production | |
| petroleum resin | | Petroleum | Hydrogenated | Example 1: | |
| | | resin | petroleum | Hydrogenated | |
| | | | resin | petroleum | |
| | | | | resin | |
| | Silicon element | 0.5 | 0.5 | 0 | — |
| | concentration (mass %) | | | | |
| | Weight-average | 1,600 | 2,400 | 1,100 | — |
| | molecular weight (Mw) | | | | |
| | Molecular weight | 2.8 | 3.9 | 2.1 | |
| | distribution (Mw/Mn) | | | | |
| | Bromine number (g/100 | 16.5 | 2.5 | 2.5 | — |
| | g) | | | | |
| | Softening point (° C.) | 94.9 | 119.2 | 102.5 | |
| | Content (mass %) | 0.5 | 0.5 | 1 | — |
| Asphalt | Kind | Straight | Straight | Straight | Straight |
| | | asphalt | asphalt | asphalt | asphalt |
| | Content (mass %) | 99.5 | 99.5 | 99 | 100 |
| Evaluation of | Peeled area ratio (%) | 40 | 50 | 95 | 100 |
| asphalt | Result | A | A | C | C |
| composition | | | | | |

From the results shown in Table 2, it was recognized that each of the asphalt compositions including the petroleum resin (B) according to the second invention of Examples 3 and 4 suppressed the peeling of the asphalt from the aggregate and improved the water resistance of the asphalt mixture as compared to each of the asphalt compositions of Comparative Examples 1 and 2.

TABLE 3
Hydrogenated Petroleum Resin (C) according to Third Invention

| | | | | Comparative | Comparative |
|---|---|---|---|---|---|
| | | Example 2 | Example 4 | Example 1 | Example 2 |
| Petroleum resin or | Kind | Production | Production | Comparative | — |
| hydrogenated | | Example 2: | Example 4: | Production | |
| petroleum resin | | Hydrogenated | Hydrogenated | Example 1: | |
| | | petroleum | petroleum | Hydrogenated | |
| | | resin | resin | petroleum | |
| | | | | resin | |
| | Silicon element | 2.9 | 0.5 | 0 | — |
| | concentration (mass %) | | | | |
| | Weight-average molecular | 1,900 | 2,400 | 1,100 | — |
| | weight (Mw) | | | | |
| | Molecular weight | 2.8 | 3.9 | 2.1 | |
| | distribution (Mw/Mn) | | | | |
| | Bromine number (g/100 g) | 2.5 | 2.5 | 2.5 | — |
| | Softening point (° C.) | 136.6 | 119.2 | 102.5 | |
| | Content (mass %) | 0.5 | 0.5 | 1 | — |
| Asphalt | Kind | Straight | Straight | Straight | Straight |
| | | asphalt | asphalt | asphalt | asphalt |
| | Content (mass %) | 99.5 | 99.5 | 99 | 100 |
| Evaluation of | Peeled area ratio (%) | 50 | 50 | 95 | 100 |
| asphalt | Result | A | A | C | C |
| composition | | | | | |

From the results shown in Table 3, it was recognized that each of the asphalt compositions including the hydrogenated petroleum resin (C) according to the third invention of Examples 2 and 4 suppressed the peeling of the asphalt from the aggregate and improved the water resistance of the asphalt mixture as compared to each of the asphalt compositions of Comparative Examples 1 and 2.

1. An asphalt composition, comprising:
a petroleum resin (A); and
straight asphalt,
wherein the petroleum resin (A) is a petroleum resin obtained by copolymerization of: a monomer comprising at least one cyclic olefin having an ethylenically unsaturated group selected from a C5 fraction, a C8 fraction, and a C9 fraction of cracked naphtha, and a cyclopentadiene-based compound; and a silane, and
wherein the petroleum resin (A) satisfies the following conditions (a1) and (a2):
(a1) the petroleum resin (A) comprises 0.1 mass % to 10 mass % of silicon element in terms of silicon atoms; and
(a2) the petroleum resin (A) has a weight-average molecular weight (Mw) of 500 to 3,000.

2. The asphalt composition according to claim 1, wherein the petroleum resin (A) satisfies the following condition (a3):
(a3) the petroleum resin (A) has a softening point of from 70° C. to 150° C.

3. The asphalt composition according to claim 1, wherein the silane has a structure represented by the following formula (1): 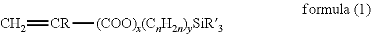
wherein
in the formula (1), R represents a hydrogen atom or a methyl group, “x” and “y” each represent 0 or 1, provided that when “x” represents 1, “y” represents 1, “n” represents an integer of from 1 to 12, and R's each independently represent an alkoxy group having 1 to 12 carbon atoms, an aryloxy group, an aralkyloxy group, an aliphatic acyloxy group having 1 to 12 carbon atoms, an amino or substituted amino group, or a lower alkyl group having 1 to 6 carbon atoms, provided that two or less of the three R′ groups are each an alkyl group.

4. The asphalt composition according to claim 1, wherein the silane is at least one selected from the group consisting of vinyltrimethoxysilane, vinyltriethoxysilane, and 3-(trimethoxysilyl) propyl methacrylate.

5. The asphalt composition according to claim 1, wherein the monomer comprises dicyclopentadiene.

6. The asphalt composition according to claim 1, wherein the petroleum resin (A) is a hydrogenated product.

7. The asphalt composition according to claim 1, wherein a content of the petroleum resin (A) in the asphalt composition is 0.1 mass % to 5 mass %.

8. An asphalt mixture, comprising:
the asphalt composition of claim 1; and
aggregate,
wherein a content of the asphalt composition is from 1 mass % to 20 mass %.

9. A petroleum resin (B), which is obtained by copolymerization of:
a monomer comprising at least one cyclic olefin having an ethylenically unsaturated group selected from a C5 fraction, a C8 fraction, and a C9 fraction of cracked naphtha, and a cyclopentadiene-based compound; and
a silane,
wherein the petroleum resin (B) satisfies the following conditions (b1) and (b2):
(b1) the petroleum resin (B) comprises 0.1 mass % to 10 mass % of silicon element in terms of silicon atoms; and
(b2) the petroleum resin (B) has a weight-average molecular weight (Mw) of 500 to 3,000.

10. The petroleum resin (B) according to claim 9, wherein the petroleum resin (B) satisfies the following condition (b3):
(b3) the petroleum resin (B) has a softening point of from 70° C. to 150° C.

11. The petroleum resin (B) according to claim 9, wherein the silane has a structure represented by the following formula (1): 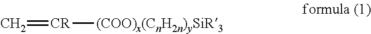
wherein
in the formula (1), R represents a hydrogen atom or a methyl group, “x” and “y” each represent 0 or 1, provided that when “x” represents 1, “y” represents 1, “n” represents an integer of from 1 to 12, and R's each independently represent an alkoxy group having 1 to 12 carbon atoms, an aryloxy group, an aralkyloxy group, an aliphatic acyloxy group having 1 to 12 carbon atoms, an amino or substituted amino group, or a lower alkyl group having 1 to 6 carbon atoms, provided that two or less of the three R′ groups are each an alkyl group.

12. The petroleum resin (B) according to claim 9, wherein the silane is at least one selected from the group consisting of vinyltrimethoxysilane, vinyltriethoxysilane, and 3-(trimethoxysilyl) propyl methacrylate.

13. The petroleum resin (B) according to claim 9, wherein the monomer comprises dicyclopentadiene.

14. The petroleum resin (B) according to claim 9, wherein the petroleum resin (B) is a hydrogenated product.

15. An asphalt composition, comprising:
the petroleum resin (B) of claim 9; and
straight asphalt.

16. The asphalt composition according to claim 15, wherein a content of the petroleum resin (B) in the asphalt composition is 0.1 mass % to 5 mass %.

17. An asphalt mixture, comprising:
the asphalt composition of claim 15; and
aggregate,
wherein a content of the asphalt composition is from 1 mass % to 20 mass %.

18. A hydrogenated petroleum resin (C), which is obtained by copolymerization of:
a monomer comprising at least one cyclic olefin having an ethylenically unsaturated group selected from a C5 fraction, a C8 fraction, and a C9 fraction of cracked naphtha, and a cyclopentadiene-based compound; and
a silane,
wherein the hydrogenated petroleum resin (C) satisfies the following conditions (c1) and (c2):
(c1) the hydrogenated petroleum resin (C) comprises 0.1 mass % to 10 mass % of silicon element in terms of silicon atoms; and
(c2) the hydrogenated petroleum resin (C) has a weight-average molecular weight (Mw) of 500 to 3,000.

19. The hydrogenated petroleum resin (C) according to claim 18, wherein the hydrogenated petroleum resin (C) satisfies the following condition (c3):
(c3) the hydrogenated petroleum resin (C) has a softening point of from 70° C. to 150° C.

20. The hydrogenated petroleum resin (C) according to claim 18, wherein the silane has a structure represented by the following formula (1): 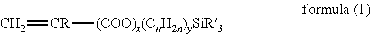
wherein
in the formula (1), R represents a hydrogen atom or a methyl group, “x” and “y” each represent 0 or 1, provided that when “x” represents 1, “y” represents 1, “n” represents an integer of from 1 to 12, and R's each independently represent an alkoxy group having 1 to 12 carbon atoms, an aryloxy group, an aralkyloxy group, an aliphatic acyloxy group having 1 to 12 carbon atoms, an amino or substituted amino group, or a lower alkyl group having 1 to 6 carbon atoms, provided that two or less of the three R′ groups are each an alkyl group.

21. The hydrogenated petroleum resin (C) according to claim 18, wherein the silane is at least one selected from the group consisting of vinyltrimethoxysilane, vinyltriethoxysilane, and 3-(trimethoxysilyl) propyl methacrylate.

22. The hydrogenated petroleum resin (C) according to claim 18, wherein the monomer comprises dicyclopentadiene.

23. An asphalt composition, comprising:
the hydrogenated petroleum resin (C) of claim 18; and
straight asphalt.

24. The asphalt composition according to claim 23, wherein a content of the hydrogenated petroleum resin (C) in the asphalt composition is 0.1 mass % to 5 mass %.

25. An asphalt mixture, comprising:
the asphalt composition of claim 23; and
aggregate,
wherein a content of the asphalt composition is from 1 mass % to 20 mass %.
